(19) United States
(12) Patent Application Publication
(10) Pub. No.: US 2020/0193859 A1
(43) Pub. Date: Jun. 18, 2020

(54) TOOL, SYSTEM AND METHOD FOR MIXED-REALITY AWARENESS EDUCATIONAL ENVIRONMENTS

(71) Applicant: CARNEGIE MELLON UNIVERSITY, Pittsburgh, PA (US)

(72) Inventors: Kenneth Holstein, Pittsburgh, PA (US); Bruce M. McLaren, Pittsburgh, PA (US); Vincent Aleven, Pittsburgh, PA (US)

(73) Assignee: CARNEGIE MELLON UNIVERSITY, Pittsburgh, PA (US)

(21) Appl. No.: 16/716,766

(22) Filed: Dec. 17, 2019

Related U.S. Application Data
(60) Provisional application No. 62/780,817, filed on Dec. 17, 2018.
(60) Provisional application No. 62/780,823, filed on Dec. 17, 2018.

(51) Int. Cl. G09B 19/00; G09B 7/00; G06T 11/00

(52) U.S. Cl. CPC G09B 19/00; G06T 11/00; G09B 7/00

(57) ABSTRACT

The present invention incorporates the use of analytics into classrooms that are equipped with education technologies, including, without limitation MED systems and ITSs, to enable human teachers to amplify their abilities and to leverage the complementary strengths of both the human teachers and the educational technologies. The present invention encompasses an educational tool system having at least one student and at least one teacher in a personalized learning environment, which includes a passive feedback system that gathers data on the student(s) and converts that data to analytics. This embodiment of the present invention also includes a real-time, wearable cognitive augmentation device that displays the analytics. This device is worn by the teacher and enables the teacher to view the data and/or analytics while engaging with the students and/or class.

### CROSS-REFERENCE TO RELATED APPLICATION

This application claims priority to U.S. Provisional Applications Ser. Nos. 62/780,817, filed Dec. 17, 2018, and 62/780,823, filed Dec. 17, 2018, which applications are incorporated by reference herein in their entirety.

### STATEMENT REGARDING FEDERALLY SPONSORED RESEARCH

This invention was made with government support under National Science Foundation award number 1530726 and Institute of Education Sciences grant number R305B150008. The government has certain rights in this invention.

### BACKGROUND OF THE INVENTION

When used in K-12 classrooms, intelligent tutoring systems (“ITSs”) can be highly effective in helping students to learn. However, they are even more effective if designed to work together with human teachers, to amplify their abilities and leverage their complementary strengths. Intelligent tutoring systems are a class of advanced learning technologies that provide students with step-by-step guidance during complex learning activities. Intelligent tutoring systems have been found, in several meta-reviews, to significantly enhance student learning compared with other learning technologies or classroom instruction. When used in K-12 classrooms, ITSs allow students to work at their own pace, while also freeing up the teacher to spend more time working one-on-one with students. Common intuition is that, in many situations, human teachers may be better suited to support students than ITSs alone (e.g., by providing socio-emotional support, supporting student motivation, or flexibly providing conceptual support when further problem-solving practice may be ineffective). Yet ITSs are not typically designed to work together with teachers, in real-time, to take advantage of these complementary strengths. As established by research on the present invention, ITSs are even more effective if they are designed, not only to support students directly, but also to amplify teachers' abilities to help their students.

The present invention encompasses a tool, system and method that incorporate a wearable, real-time teacher awareness device, such as mixed-reality smart glasses, that tune teachers in to the rich analytics generated by ITSs and alert teachers to situations that the ITS may be ill-suited to handle. The present invention and related research demonstrate that presenting teachers with real-time analytics about student learning, meta-cognition, and behavior has a positive impact on student learning. The system, method and tool of the present invention can help to narrow the gap in learning outcomes across students of varying prior ability and enhance student learning.

### DESCRIPTION OF THE RELATED ART

When educational technologies are used in K-12 classrooms, human teachers play critical roles in mediating their effectiveness. The term classroom orchestration has been widely used to describe the planning and real-time management of classroom activities. Supporting teachers in orchestrating complex, but effective, technology-enhanced learning has been recognized as a critical research and design challenge for the learning sciences.

In recent years, several real-time teacher awareness tools have been designed and developed to address this challenge. These tools are often designed to augment teachers' “state awareness” during ongoing learning activities, for example, by presenting teachers with real-time analytics on student knowledge, progress, metacognition and behavior within educational software. The design of such tools is frequently motivated by an assumption that enhanced teacher awareness will lead to improved teaching, and consequently, to improved student outcomes. Some prior work has found evidence of positive effects of real-time teacher analytics on student performance within educational software. Yet there is a paucity of empirical evidence that a teacher's use of real-time awareness tools (e.g., dashboards) can improve student learning, and scientific knowledge about the effects such tools have on teaching and learning is scarce.

Personalized learning software, when used in classrooms, allows students to work at their own pace, while freeing up the teacher to spend more time working one-on-one with students. Yet such personalized classrooms also pose unique challenges for teachers, who are tasked with monitoring students and classes working on divergent activities, and prioritizing help-giving in the face of limited time.

In recent years, there has been increasing interest in personalized classroom models within K-12 education. In personalized classrooms, students progress along individualized learning pathways, while the teacher's role is transformed from that of a lecturer at the front of the class to that of a facilitator of students' self-paced learning. To support this kind of highly personalized instruction, schools are increasingly using personalized learning software in their classrooms.

One form of personalized learning software, ITSs, allows students to work at their own pace while providing detailed, step-by-step guidance through complex learning activities. Intelligent tutoring systems are a class of advanced learning technologies that provide students with step-by-step guidance during complex problem-solving practice and other learning activities. These systems continuously adapt instruction to students' current “state” (a set of measured variables, which may include moment-by-moment estimates of student knowledge, metacognitive skills, affective states, and more). Several meta-reviews have indicated that ITSs can enhance student learning, compared with other learning technologies or traditional classroom instruction. However, ethnographic studies have revealed that, in K-12 classroom settings, teachers and students often use ITSs in ways not originally anticipated by ITS designers. For example, Schofield et al. (Teachers, Computer Tutors, and Teaching: The Artificially Intelligent Tutor as an Agent for Classroom Change. AERJ. 31, 3 (1994), 579-607) found that, rather than replacing the teacher, a key benefit of using such artificial intelligence (“AI”) tutors in the classroom may be that they free teachers to provide more individualized help while students work with the tutor. Although students tended to perceive that teachers provide better one-on-one help than an ITS, they also preferred ITS class sessions over more traditional sessions—in part because of this shift in teacher-student interactions.

Recently, some work has begun to explore the value ITSs might provide to teachers in K-12 classrooms, and to investigate teachers' needs and desires for real-time support in ITS classrooms. However, the design of effective support tools for teachers working in these contexts remains a largely open, challenging problem. A series of user-centered design interviews with middle school math teachers explored teachers' needs in K to 12 classrooms that use ITSs. In those interviews, teachers indicated a desire to perceive information about individual students' learning and behavior, in real-time. For example, all interviewed teachers wanted to be able to instantly see when a student is “stuck” (even if that student is not raising her/his hand), to instantly detect when a student is off-task or otherwise misusing the software, and to be able to see students' step-by-step reasoning, unfolding in real-time. The present invention solves many of the existing shortcomings and problems with using ITSs and goes beyond solving those problems to address many of these stated teacher needs and desires when teaching in personalized learning environments more broadly.

In research discussions, teachers liked the idea of being able to see student information “floating over students' heads”, directly within the physical classroom environment. (K. Holstein, G. Hong, M. Tegene, B. M. McLaren, and V. Aleven. 2018. The Classroom as a Dashboard: Co-designing Wearable Cognitive Augmentation for K-12 Teachers. In Proceedings of the International Conference on Learning Analytics and Knowledge, Sydney, Australia, March 2018 (LAK'18)). Teachers were particularly receptive to awareness tool designs that allowed them to keep their heads up and their attention focused on the classroom. Teachers emphasized that some of the most useful real-time information comes from reading student body language and other cues that would not be captured by a dashboard alone. They gravitated towards the idea of wearing eyeglasses that could provide them with a private view of actionable information about their students in real-time, embedded throughout the classroom environment (e.g., through state indicators 70 displayed directly above students' heads). While these “teacher smart glasses” would have many of the same advantages as ambient and distributed classroom awareness tools for teachers that are currently available, they would not reveal sensitive student data for the whole class to see—a risk that several teachers referred to as a “deal-breaker” for use in middle school classrooms. Again, the present invention is designed to address all of these teacher needs and desires and to enhance teaching in personalized learning environments.

Finally, similar to earlier findings by Martinez-Maldonado et al. (MTFeedback: Providing Notifications to Enhance Teacher Awareness of Small Group Work in the Classroom. IEEE TLT. 8, 2 (2015) 187-200) in the context of collaborative, multi-tabletop classrooms, there is preliminary evidence that teacher awareness of students' struggle in ITS classrooms may be limited. In classroom field studies, although teachers reported focusing their attention on students whom they thought needed help the most, teacher time allocation during ITS class sessions was not significantly related to either students' prior domain knowledge or learning gains. These findings suggest that there is room for improvement via a real-time support tool, such as the present invention's system, method and tool.

An additional advantage of ITSs, when used in classrooms, is that they free up the teacher to spend more time working one-on-one with students. However, they also present teachers with unique challenges, as teachers are tasked with monitoring classrooms that are likely working on a broad range of divergent educational activities at any given time. The present invention addresses this need for usable real-time orchestration tools that can support teachers in monitoring personalized classrooms and effectively allocates help and attention across students, in the face of limited time.

Prior work in Learning Analytics and Human-Computer Interaction has adopted user-centered and participatory approaches to the design of real-time awareness tools for teachers working in personalized classrooms. However, most of this work has focused on designing tools for university-level instructors and on active feedback systems, where the student pushes information to the teacher to indicate and understanding or lack of understanding of the lecture topic. This pushing of information from the student to the teacher is an example of an “active” feedback system; one in which the student intentionally sends information to the teacher. The present invention focuses on better understanding K-12 teachers' real-time information needs in personalized classrooms where the student data is gathered passively on the student (a “passive” feedback system) instead of actively from the student. However, it will be obvious to one skilled in the art that the present invention works in both active and passive feedback systems and both are included within the scope of the invention. Additionally, recent design and ethnographic work has begun to investigate the potential of emerging wearable technologies for teacher support. Such technologies hold great promise to enhance teacher awareness, while allowing teachers to keep their heads up and eyes focused on their classroom—acknowledging the highly active role teachers play in personalized classrooms. The present invention tool, system and method capitalize on this ability to enable teachers to view student analytics while keeping their heads up and eyes focused on the classroom.

### BRIEF SUMMARY OF THE INVENTION

The present invention encompasses a real-time awareness system, method and tool for teachers working in any educational environment, but particularly in personalized learning environments, including but not limited to K-12 classrooms using intelligent tutoring systems, artificial intelligence-enhanced classrooms, and blended classrooms. Three broad embodiments of the present invention include a system, method and tool for use in educational settings comprising: a computer-based learning environment for students and a wearable tool that processes and displays real-time analytics gathered from the computer-based learning environment. One embodiment of the present invention's system and method of creating mixed-reality awareness in artificial intelligence-enhanced classrooms uses mixed-reality smart glasses, which tune teachers in to the rich analytics generated by ITSs.

Another embodiment of the present invention is an educational tool system having at least one student and at least one teacher in a personalized learning environment. This embodiment includes a passive feedback system that gathers data on the student(s) and converts that data to analytics. Those analytics may include, among other things, student-specific analytics and/or student-combined analytics (also referred to herein as classroom analytics.) This embodiment of the present invention also includes a real-time, wearable cognitive augmentation device that displays the analytics. This device is worn by the teacher and enables the teacher to view the data and/or analytics while engaging with the students and/or class.

Another embodiment of the present invention is an educational tool system having at least one student and at least one teacher in a personalized learning environment with a gathering system that gathers data from the student(s) and a processing system that converts the data into analytics. The analytics may include, among other things, student-specific analytics and student-combined analytics. This embodiment also uses a real-time, wearable cognitive augmentation device that receives and displays the analytics for the teacher to view while engaging with the students and/or class.

A third embodiment of the present invention is a method of teaching in a personalized learning environment having at least one student and at least one teacher. The method, according to this embodiment of the invention, comprises the steps of passively gathering data on the student(s); processing the data into at least one type of analytics selected from the group consisting of student-specific analytics and student-combined analytics; and displaying the analytics on a real-time, wearable cognitive augmentation device worn by the at least one teacher.

Another embodiment of the present invention includes a method of teaching in a personalized learning environment having at least one student and at least one teacher This method includes the steps of passively gathering data about the at least one student; processing the data to generate analytics selected from the group consisting of student-specific analytics and student-combined analytics; and displaying the analytics on a real-time, wearable cognitive augmentation device worn by the at least one teacher.

One embodiment of the present invention includes a system for use in educational settings in a personalized learning environment. The system of this embodiment uses a real-time, wearable cognitive augmentation device, where the device provides analytics of data gathered from the personalized learning environment in real time.

Another embodiment of the present invention is a method for use in educational settings having the steps of gathering and processing student data from a personalized learning environment to generate analytics and displaying the analytics on a real-time, wearable cognitive augmentation device.

One embodiment of the present invention is a system for use in educational settings having a computer-based personalized learning environment for students and a wearable tool that processes and displays in real time analytics gathered from the computer-based personalized learning environment.

One other embodiment of the present invention is a system for use in education settings which includes a wearable tool that presents a teacher with rich, real-time analytics gathered based on one or more student's ongoing interactions within a computer-based learning environment, whereby the analytics are presented to the teacher continuously and in real-time to augment the teacher's perceptions and decision making.

### BRIEF DESCRIPTION OF THE DRAWINGS

For the purpose of facilitating understanding of the invention, the accompanying drawings and description illustrate preferred embodiments thereof, from which the invention, various embodiments of its structures, construction and method of operation, and many advantages, may be understood and appreciated.

FIGS. 1A and 1B show a teacher's point-of-view while using one embodiment of the present invention and specifically show illustrative mock-ups;

FIGS. 1C and 1D show a teacher's point-of-view while using one embodiment of the present invention and specifically show screenshots captured through one embodiment of the present invention (taken after the end of a class session to protect student privacy);

FIGS. 2A and 2B show a list of possible indicators displayed by one embodiment of the present invention and an image of a teacher using the present invention;

FIG. 3 shows student pre/post learning, by experimental condition, where error bars indicate standard error;

FIG. 4 shows student posttest scores (top) and teacher attention allocation (bottom), plotted by student pretest scores, for each experimental condition (shaded regions indicate standard error);

FIG. 5 shows the estimated effects of condition (rows) on teachers' allocation of time to students exhibiting each within-tutor behavior/state (columns), where cells report estimated effect sizes of ***p<0.001, **p<0.01, *p<0.05, and ˜0.05≤p<0.07;

FIG. 6 shows the estimated effects of condition (rows) on the frequency of student within-tutor behavior/states (columns), where ***p<0.001, **p<0.01, *p<0.05, and ˜0.05≤p<0.07;

FIG. 7 shows a table of demographic information for schools;

FIG. 8 shows a sample of real-time indicators;

FIGS. 9A and 9B show indicators and deep-dive screens according to one embodiment of the present invention;

FIGS. 10A and 10B show indicators and deep-dive screens according to one embodiment of the present invention; and

FIG. 11 is a table showing the relationships between teacher time allocation (in seconds) and students' prior knowledge and learning.

### DETAILED DESCRIPTION

The following describes example embodiments in which the present invention may be practiced. This invention, however, may be embodied in many different ways, and the description provided herein should not be construed as limiting in any way. Among other things, the following invention may be embodied as methods or devices. The following detailed descriptions should not be taken in a limiting sense. Additionally, the figures are all hereby incorporated by reference.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

While the disclosure has been described in detail and with reference to specific embodiments thereof, it will be apparent to one skilled in the art that various changes and modifications can be made therein without departing from the spirit and scope of the embodiments. Thus, it is intended that the present disclosure covers the modifications and variations of this disclosure provided they come within the scope of the appended claims and their equivalents.

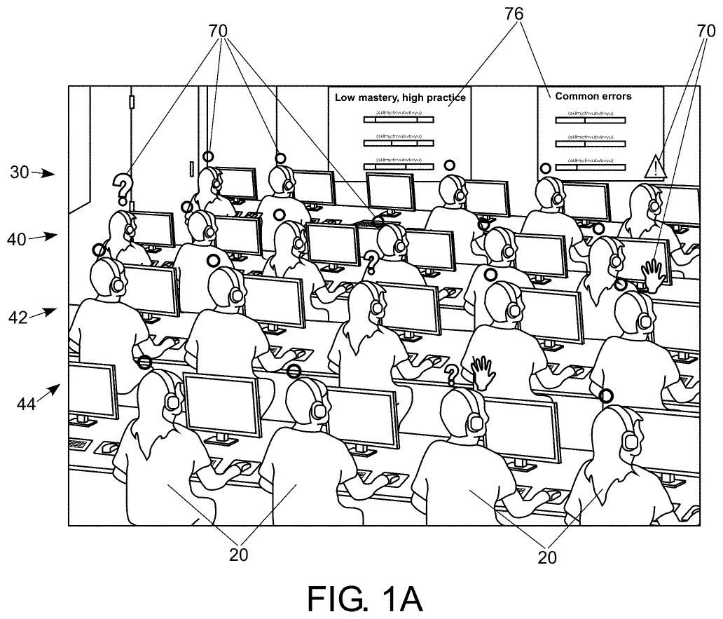

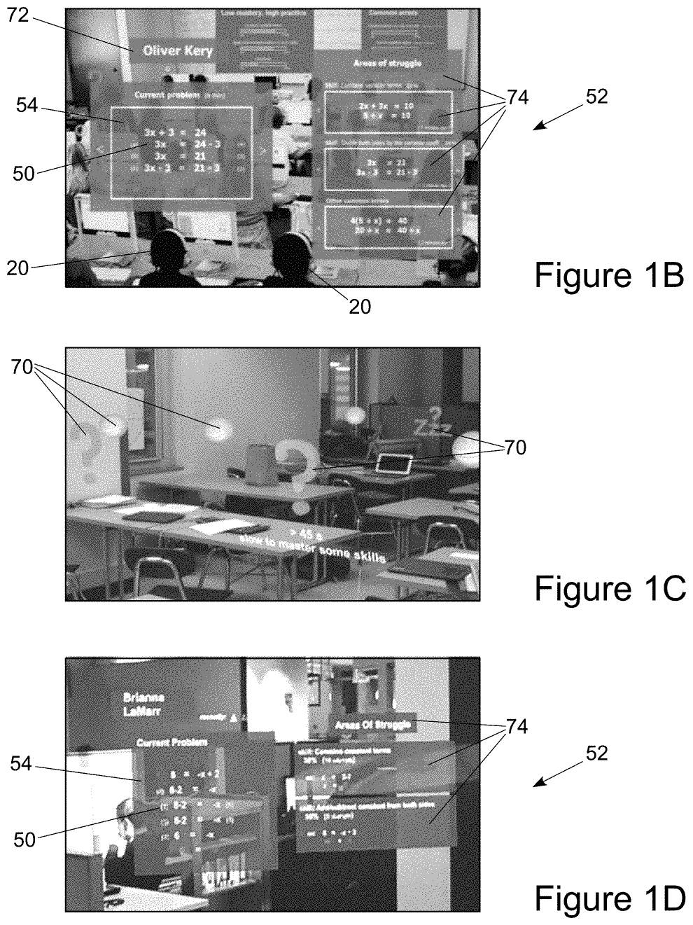

The present invention encompasses a real-time awareness system, method and tool for teachers 22 working in any learning environment, but particularly in K-12 classrooms using intelligent tutoring systems, artificial intelligence-enhanced classrooms, and blended classrooms (as illustrated in FIGS. 1 and 2). It will be apparent to one skilled in the art that, while the present invention's use with ITSs is described, alternative embodiments of the present invention include use with artificial intelligence in education (“AIED”) systems, personalizing learning environments, personalized learning software, artificial intelligence tutors, blended classrooms and many different types of educational technologies that can, or can be modified to, interface with students (collectively referred to herein as “personalized learning environment(s) 30”). More broadly, personalized learning environments 30 include all learning environments in which students 20 or groups of students 20 work at their own pace. All such personalized learning environments 30 are encompassed by and included within the present invention. Additionally, the description of the present invention discloses its use in classrooms; however, it will be apparent to one skilled in the art that the invention can be used in any type of educational environment that is equipped as described herein and all such educational environments are hereby incorporated into the present invention.

Three broad embodiments of the present invention include a system, method and tool for use in educational settings comprising: a personalized learning environment 30 for students 20 and a wearable device 60 that optionally processes and displays real-time analytics 52 gathered from the personalized learning environment 30 (as shown in FIG. 2b). More specifically, many of the embodiments of the present invention described herein incorporate a real-time, wearable cognitive augmentation device 60. The phrase “real-time, wearable cognitive augmentation device” and variations thereon, refer to wearable devices or tools 60 for teachers 22 or educators 22 that provide the teachers 22 with real-time analytics 52 that are generated based upon the student(s)' and/or the teacher(s)' activities. These real-time, wearable cognitive augmentation devices 60 present real-time information to the teacher 22 in such a way so as to augment the teacher's perceptions and decision-making during on-going classroom activities. The use of the phrase “real-time” in this context refers to the display of analytics 52 during the teacher's on-going activities, often presented in order to support those activities. “Real-time” does not require that the data 50 come from the students' current, on-going activities. The data 50 and analytics 52 that are displayed to the teacher 22 may be collected from past activities (for example, analytics 52 based on historical data 50 or historical trends) or current, on-going student activities. However, the data 50 (current and/or past) and the related analytics 52 are displayed in “real-time” as the teacher 22 is teaching the class. Additionally, while the present invention envisions the gathering of data 50 and the conversion of this data 50 to analytics 52 that are displayed for the teacher 22, the conversion of the data 50 to analytics 52 may involve processing the data 50 into different information or it may simply be converting the data 50 into a form that can be displayed to the teacher 22. Thus, the term “analytics” 52 encompasses any information that will be displayed to the teacher 22, including but not limited to the raw data 50. The following is a non-exclusive list of examples of different types of and sources for data 50 and analytics 52 for the present invention:
Data 50 source: interaction log data (or “telemetry data”) from an ITS or other personalized learning software or other educational software (e.g., DataShop log data or exchanges between students 20 in a chat window of an educational application or verbal dialogue exchanges between students 20 and/or teachers 22 in a voice-based chat window of an educational application or measurements of elapsed time between student actions or histories of student keystrokes and inputs in a screen-based educational application etc.);
Data 50 source: sensor stream data 50 (e.g., cameras, accelerometers, EEGs, etc.) from an instrumented classroom or an instrumented informal learning environment or a learning environment in which students 20 and the teacher 20 are instrumented with wearable sensors;
Analytic 52: skills for which a student 20 has a low probability of mastery or skills for which a student 20 has a high probability of mastery (e.g., as measured by a student modeling method such as Bayesian Knowledge Tracing or Individualized Bayesian Knowledge Tracing or other variants of Bayesian Knowledge Tracing or the Additive Factors Model or any other method to measure skill performance or probability of knowledge of a skill etc.);
Analytic 52: a list of students 20 in a class who are struggling with a given skill;
Analytic 52: a list of students 20 in a class who are performing well on a given skill;
Analytic 52: a list of students 20 in a class that are currently well-prepared to learn a given skill that they have not yet learned;
Analytic 52: a list of students 20 in a class who seem to be on the verge of mastering a given skill;
Analytic 52: a list of pairs of students 20 in a class who, at a given moment, may be a good match for peer tutoring (e.g., because one student 20 has mastered the given skill and the other student 20 is currently struggling with the given skill);
Analytic 52: a concrete example of an error that a certain student 20 in a class has made on a recent practice opportunity for a given skill;
Analytic 52: a concrete example of a type of error that many students 20 in the class have made on a recent practice opportunity for a given skill;
Analytic 52: skills for which a class currently has had many practice opportunities but which have been mastered by only a small percentage of students 20;
Analytic 52: skills for which a class currently has had very few practice opportunities but which have been mastered by a large percentage of students 20;
Analytic 52: the number of times a student 20 has asked for help from a software agent (e.g., an ITS) during a specific period of time;
Analytic 52: the number of times a student 20 has asked for help from a teacher 22 during a specific period of time;
Analytic 52: the number of times a student 20 has asked for help from a peer/fellow student 20 during a specific period of time;
Analytic 52: the number of times a student 20 has asked for help, made an error, got a step correct on their first try, or any other number of metrics along these lines on a particular step in an educational task recently;
Analytic 52: the number of times a student 20 has asked for help or made an error or got a step correct on their first try or (any other number of metrics along these lines) with a particular kind of skill in an educational task during a specific period of time;
Analytic 52: the number of times a student 20 has asked for help, made an error, got a step correct on their first try, or any other number of metrics along these lines on the last 5 educational activities they have worked on;
Analytic 52: the measure of a student's or teacher's heart rate or that heart rate meeting a certain threshold;
Analytic 52: the frequency with which the student 20 or teacher 22 been circulating around the room;
Analytic 52: determining whether the student 20 or teacher 22 currently is frustrated;
Analytic 52: determining whether the student 20 or teacher 22 currently is bored;
Analytic 52: determining whether the student 20 or teacher 22 currently is concentrating;
Analytic 52: determining whether the student 20 or teacher 22 currently is on-task or off-task;
Analytic 52: determining whether the student 20 or teacher 22 currently is confused;
Analytic 52: determining whether the student 20 or teacher 22 currently is angry;
Analytic 52: determining whether the student 20 or teacher 22 currently is engaged in discussion;
Analytic 52: evaluating how has the student 20 or teacher 22 been distributing their time across students 20, when providing peer tutoring or one-on-one help;
Analytic 52: a list of students 20 in the class whom the teacher 22 or a student 20 (peer tutor) has not visited in a long time;
Analytic 52: an alert that a student 20 has been exhibiting a particularly “low” or “high” recent error rate;
Analytic 52: a student 20 is making errors on a given problem-solving step, despite having already exhausted all automatically-provided hints for that step;
Analytic 52: a student 20 is avoiding help (whether from a software agent, the teacher 22, peers 20, etc.);
Analytic 52: a student 20 is abusing help (whether from a software agent, the teacher 22, peers 20, etc.);
Analytic 52: a student 20 is gaming-the-system or otherwise misusing educational resources available to them;
Analytic 52: a student 20 is making many non-deliberate or seemingly random actions;
Analytic 52: a student 20 is “spinning their wheels” with respect to certain educational skills or activities, and is unlikely to make progress without help;
Analytic 52: the educational resources available to a student 20 (e.g., an educational software agent) is predicted to be insufficient to effectively help a given student 20 at a given point in time, thus, additional help is needed;
Analytic 52: the amount of time a student 20 has spent on their current educational activity;
Analytic 52: the amount of time a student 20 has spent on their current educational activity, compared with previous students 20;
Analytic 52: the amount of time students 20 in a class, on average, have spent on their current educational activity, compared with previous students 20;
Analytic 52: the amount of “productive time” a student 20 has spent on educational activities within a given time window (e.g., within the last 30 minutes, the last hour, the last day, the last week, or the last year, etc.);
Analytic 52: the average number of saccades a student 20 makes while reading (e.g., computed based on eye-tracking data 50);
Analytic 52: the frequency with which a student 20 (serving as a peer tutor for another student 20) is simply “giving away the answer”;
Analytic 52: the frequencies with which a student 20 has recently rejected or accepted automated invitations to peer tutor other students 20;
Analytic 52: the frequencies with which a teacher 22 has helped students 20 on a given skill within their educational activities, within a given time window (e.g., the last 30 minutes, the last hour, the last day, the last week, or within the last year, etc.);
Analytic 52: the frequency, and with what severity, the students 20 in a culinary arts class have been making errors in cutting (for example, with a knife or the cutting board having incorporated sensors);
Analytic 52: the types of cutting errors the students 20 in a culinary arts class have been making errors in cutting (for example, with a knife or the cutting board having incorporated sensors);
Analytic 52: how effective a teacher 22 or peer tutor's help recently has been in helping students 20 get unstuck in their ongoing educational activities;
Analytic 52: to what extent, and in what ways, have students' performance and behavior during class differed from a teacher's prior expectations (where expectations are elicited—e.g., automatically by the tool—from the teacher before class);
Analytic 52: the likelihood that the educational software that a student 20 is working with to push a student 20 to a different activity (due to lack of progress or lack of expected progress);
Analytic 52: which students 20 in a class have been making similar errors on their ongoing educational activities, and what are those errors;
Analytic 52: which students 20 in a class have been exhibiting similar strategies during ongoing educational activities, and what are those strategies;
Analytic 52: automated recommendations, based on student and/or teacher data 50, about which student (or students) 20 a teacher 22 or peer tutor should help next;
Analytic 52: automated recommendations, based on student and/or teacher data 50, about what type of help a teacher 22 or peer tutor should provide a given student (or group of students) 20 next;
Analytic 52: automated recommendations, based on student and/or teacher data 50, of specific activities or exercises a teacher 22 or peer tutor should assign to a given student (or group of students) 20 next;
Analytic 52: automated judgments of how well a student 20 is regulating their own learning (e.g., in contexts where the student 20 has control over which educational activities they work on and/or are they selecting educational activities at an appropriate level of challenge);
Analytic 52: teacher 22 may use their wearable device 60 at the start of the class to quickly review analytics 52 about how students 20 did on previous day's personalized/self-paced homework (or any historical data 50), to guide the teacher 22 in leading in-class discussions with the whole class, relevant subsets of students 20, and/or individual students 20; and/or
Analytic 52: any logical combination of any of the analytics 52 and/or data 50 listed above or any analytics 52 and/or data 50 that are able to be collected, measured, observed, analyzed, or deduced, etc.

All of the embodiments of the present invention included a real-time, wearable cognitive augmentation tool or device 60 that displays the real-time analytics 52. The wearable device 60 may continuously augment the teacher's real-time perceptions and decision-making in the classroom by displaying any desired analytics 52 using an interface that allows the teacher 22 to keep his/her head up and focused on the classroom and/or student(s) 20. This heads-up aspect enables the teacher 22 to continue monitoring signals from the students 20 and/or the class that may not be captured by the educational tool system 10 alone, such as a student's body language or facial expressions. The heads-up aspect of the present invention also enables the teacher 22 to engage with the student(s) 20 while using the educational tool system 10 and method of the present invention. This ability to engage with the student(s) 20 encompasses any type of student(s) 20 and teacher 22 interaction, including but not limited to the teacher 22 talking to or with the student(s), monitoring the student(s)' body language, listening to talk and noise in the classroom, and remaining present in and aware of what is happening within the personalized learning environment 30 while having access to the analytics 52.

There are numerous technologies available that can be incorporated into the present invention to act as the real-time, wearable cognitive augmentation device 60. Some non-limiting examples include wearable head-up displays designed for peripheral interactions, smart watches, smart glasses 62, Microsoft HoloLens®, Google Glass®, mixed reality glasses and computerized heads-up display. Additionally, while some embodiments of the present invention are described herein in conjunction with smart glasses technology, these and other embodiments of the present invention may be adapted to be used with any type of real-time, wearable cognitive augmentation devices 60 to implement the systems and methods of the present invention. One such non-limiting example would be a watch that discreetly displays information similar to that which is displayed by the glasses 62. All such wearable computing devices are included in the present invention.

Additionally, the present invention method, system and tool are used in personalized learning environments 30 and for some embodiments, personalized, non-synchronized learning environments 30. These are learning environments in which students 20 or student groups work at their own pace. One non-limiting example of such an environment 30 is a classroom using an ITS. Within these personalized learning environments 30, the passive feedback system 40, data gathering system 42 and data processing system 44 may be combined into one software program, methods, technologies and related hardware. Alternatively, each of these elements (the personalized learning environments 30, the passive feedback system 40, data gathering system 42 and data processing system 44) may be accomplished by different software programs, methods, technologies and hardware. Similarly, in various embodiments of the present invention, the gathering system 42 and the processing system 44 may be distributed across multiple devices (e.g., part of the processing may happen in the student-facing system (which would be part of the personalized learning environment 30) while other parts happen in the teacher-facing system (the wearable device 60)). However, in most embodiments, the processing system 44 is incorporated solely into the student-facing system or solely into the teacher-facing system. Some non-liming example sources for gathering the data 50 from the students 20 and/or from the personalized learning environment 30, include the following: computers, ITSs, tools and/devices with sensors, video(s) of classroom, recording devices to record speech in classroom, etc.

One embodiment of the present invention's educational tool system 10 and method of creating mixed-reality awareness in artificial intelligence-enhanced classrooms or personalized learning environments 30 uses mixed-reality smart glasses 62, which tune teachers 22 in to the rich analytics 52 generated by ITSs. By alerting teachers 22 in real-time to situations the ITS may be ill-suited to handle on its own, the educational tool system 10 and method of the present invention facilitate a form of mutual support or co-orchestration between the human teacher 22 and the AI tutor or program. While many examples of the present invention will be discussed herein using math curriculum and math teachers 22, it will be obvious to one skilled in the art that this invention can be adapted to any academic course, field of study or subject matter and used by teachers 22 and educators 22 in a variety of personalized learning environments 30.

Various embodiments of the present invention were evaluated using a 3-condition experiment with 286 middle school students 20, across 18 classrooms and 8 teachers 22. In that research, it was found that presenting teachers 22 with real-time analytics 52 about student learning, meta-cognition, and behavior had a positive impact on student learning, compared with both business-as-usual and classroom monitoring support without advanced analytics 52. These findings suggest that real-time teacher analytics 52 help to narrow the gap in learning outcomes across students 20 of varying prior ability.

The research of the various embodiments of the present invention involved a teacher's 22 use of a real-time awareness educational tool system 10 in the context of middle school classrooms using Lynnette™, an ITS for linear equations. Lynnette™ is a rule-based Cognitive Tutor that was developed using the Cognitive Tutor Authoring Tools. It has been used in several classroom studies, where it creates a personalized learning environment 30 and has been shown to significantly improve students' equation-solving ability. Lynnette™ provides step-by-step guidance, in the form of hints, correctness feedback, and error-specific messages as students 20 tackle each problem in the software. It also adaptively selects problems for each student 20, using Bayesian Knowledge Tracing (“BKT”) to track individual students' knowledge growth, together with a mastery learning policy. Thus, Lynnette™ creates a passive feedback system 40 by gathering information or data 50 on the individual students 20 and processing that data 50 into analytics 52 that are useful to the teacher 22. In this embodiment of the present invention using Lynnette™, much (but not all) of the data 50 is collected through Lynnette™. However, the teacher-facing tool (which in this embodiment is mixed-reality smart glasses 62) also collects and processes data 50 (e.g., in some cases data 50 is collected through Lynnette™, processed through the teacher-facing tool 60). In many embodiments, some data 50 is collected through the student-facing tool (the personalized learning environment 30), some data 50 is collected through the teacher-facing tool (the real-time, wearable cognitive augmentation device 60), and some data 50 is processed through either the student-facing tool or the teacher-facing tool. Students 20 using Lynnette™ progress through five levels with equation-solving problems of increasing difficulty. These range from simple one-step equations at Level 1 (e.g., x+3=6), to more complex, multi-step equations at Level 5 (e.g., 2(1−x)+4=12). While some embodiments of the present invention were developed using Lynnette™, it will be apparent to one skilled in the art that the present invention can be adapted for use with many different types of ITSs, AIED, blended classroom technologies (all included within the concept of personalized learning environments 30) and the current invention is not limited to use with Lynnette™ Additionally, in those embodiments developed with Lynnette™, Lynnette™ serves multiple roles in the educational tool system 10 (the personalized learning environment 30, the passive feedback system 40, and the gathering system 42), in other embodiments of the present invention each of these elements can be accomplished by separate or combined hardware, software, applications and/or programs.

As explained, the present invention encompasses an educational tool system 10 and method to aid teachers 22 in orchestrating personalized learning environments 30 in which students 20 work on divergent educational activities at their own pace. This invention enables a teacher 22 to privately perceive in real-time data 50 and analytics 52 on the students' use of the educational technology in the classroom. In one embodiment of the present invention, the teacher 22 experiences the classroom as a seamless mixture of physical reality and virtual information displays. This seamless mixture, when combined with a real-time, wearable cognitive augmentation device 60, enables the teacher 22 to move around the learning environment 30 and to interact with individual students 20 and/or the class as a whole, while viewing student-specific analytics 54 and/or student-combined analytics 56.

To create this seamless mixture of physical reality and virtual information, every embodiment of the present invention incorporates a real-time, wearable cognitive augmentation device 60. However, the exact embodiment of that wearable device 60 can take a wide variety of forms, as discussed previously. One embodiment of the present invention utilizes a pair of mixed-reality smart glasses 62 and related software/application/programming, which are incorporated into the present invention's educational tool system 10 and method of using a real-time mixed-reality device 60 in artificial intelligence-enhanced learning environments. The present invention presents indicators 70 of students' current learning, metacognitive, and behavioral “states” real-time, projected in the teacher's view of the classroom. Some example views of the class view are shown in FIGS. 1A and 1C. The use of transparent smart glasses 62 allows teachers 22 to keep their heads up and focused on the classroom, enabling them 22 to continue monitoring important signals that may not be captured by the educational tool system 10 alone (e.g., student body language and facial expressions). The smart glasses 62 provide teachers 22 with a private view of actionable, information about their students 20 real-time, embedded throughout the classroom environment, thus providing many of the advantages of ambient and distributed classroom awareness tools, and, in some embodiments, without revealing sensitive student information to the entire class. This privacy element of some embodiments of the present invention is a significant advantage over other technologies that are currently available, particularly in K-12 classrooms. It enables teachers 22 to identify students 20 who may be too shy or too embarrassed to request help in a more open or obvious manner, like raising their hands. It also enables teachers 22 to provide positive reinforcement to students 20 who are successfully working with the ITS and, thus, encourage a behavior that may have otherwise been overlooked. The real-time, wearable cognitive augmentation devices 60 used in conjunction with the present invention enable teachers 22 to simultaneously or alternatively view the classroom and the students 20 while monitoring signals and analytics 52 from the educational tool system 10.

One embodiment of the present invention utilizes mixed-reality smart glasses 62 that have minimalistic information display designs (with progressive disclosure of additional analytics 52 only upon a teacher's request), in accordance with the level of information teachers 22 desire and can reasonably handle in fast-paced classroom environments. The mixed-reality smart glasses 62 of this one embodiment present mixed-reality displays of three main types, all visible through the teacher's glasses 62: student-level indicators 72, student-level “deep-dive” screens 74, and class-level summaries 76, as shown in FIGS. 1A through 1D. In one embodiment of the present invention, student-level indicators 72 and class-level summaries 76 are always visible to the teacher 22 by default, at a glance. For example, student-level indicators 72 are displayed above corresponding students' heads (based on teacher-configurable seating charts), and class-level summaries 76 are displayed at teacher-configurable locations throughout the classroom. Some non-limiting examples of student-level indicators 72 are shown in FIG. 2A. As shown in FIG. 1C, if a teacher 22 glances at a student's indicator 70, the mixed-reality smart glasses 62 of this one embodiment of the present invention automatically display a brief elaboration about the currently displayed indicator 70 (i.e., how long the alert has been active and/or a brief explanation of why the alert is showing). If no indicators 70 are currently active for a student 20, the glasses 62, according to this embodiment, display a faint circular outline above that student 20 (FIG. 1A). FIGS. 1A and 1C are examples of a teacher's default view of the class through this one embodiment of the present invention. If a teacher 22 clicks on a student's indicator 70 (using either a handheld clicker or by making a ‘tap’ gesture in mid-air or by other input/instruction device or mechanism), this one embodiment of the present invention's real-time, wearable cognitive augmentation device 60 displays “deep-dive” screens 74 for that student 20. As shown in FIGS. 1B and 1D, these screens 74 may include a “Current Problem” display, which supports remote monitoring, showing a live feed of a student's work on their current problem. Each problem step in this feed can be annotated with the number of hint requests and errors the student 20 has made on that step. This one embodiment of the present invention enables monitoring of student activities from a distance (i.e., across the room) and teachers 22 using such an embodiment can interleave help across students 20: while helping one student 20 at that student's seat, the teacher 22 might provide quick guidance to a struggling student 20 across the room. Such a situation is depicted in FIG. 2B.

In some embodiments of the present invention, the deep-dive screens 74 also may include an “Areas of Struggle” screen, which displays the three skills for which a student 20 has the lowest probability of mastery (or any chosen deep-dive information). For each skill shown in “Areas of Struggle”, the student's estimated probability of mastery can be displayed, together with a concrete example of an error the student 20 has made on a recent practice opportunity for the skill. In addition, in the current study, a class-level summary 76 display may be available to the teacher 22, such as the “Low Mastery, High Practice” shown in FIG. 1A. This optional display shows the three skills that the fewest students 20 in the class have mastered (according to BKT), at a given point in the class session, out of those skills that many students 20 in the class have already had opportunities to practice within the personalized learning environment 30 software.

The student indicators 72 displayed by one embodiment of the present invention as shown in FIG. 2A are non-limiting examples of indicators 70 that are used with the present invention. However, it will be obvious to one skilled in the art that any data 50 that can be gathered on the students 20 and from the personalized learning environment 30 can be converted to an almost unlimited number of analytics 52, which can be displayed as indicators 70 to the teacher 22. The various embodiments of the present invention include any and all analytics 52 and indicators 70 that can be generated and displayed.

In research on the present invention, the analytics 52 and their corresponding indicators 70 of one embodiment of the present invention were iteratively refined based on prototyping feedback from teachers 22, as well as causal data mining of teacher and student process data 50 from classroom pilots using the mixed-reality smart glasses 62 of one embodiment of the present invention. The results enabled updates to the real-time student indicators 72 based on the outputs of sensor-free detectors, including detectors of student hint abuse and hint avoidance, gaming-the-system, rapid/non-deliberate step attempts or hint requests, and unproductive persistence or “wheel-spinning.” In addition, the mixed-reality smart glasses 62 of this embodiment of the present invention indicate when a student 20 has been idle for two minutes or more and may be off-task, when a student 20 has been exhibiting a particularly “low” or “high” recent error rate (less than 30% or greater than 80% correct within the student's most recent 10 attempts), or when a student 20 is making errors on a given problem-solving step, despite having already exhausted all tutor-provided hints for that step. By directing the teachers' attention, in real-time, to situations the ITS may be ill-suited to handle, this embodiment of the present invention is designed to facilitate productive mutual support or co-orchestration between the teacher 22 and the ITS (as incorporated within the personalized learning environment 30), by leveraging the complementary strengths of each. While FIG. 1A through 1D and FIG. 2 show the analytics 52 and indicators 70 that were used for one particular set of math students 20 and teachers 22, it will be obvious to one skilled in the art that the analytics 52 and indicators 70 gathered by, used by and displayed by the present invention may be customized to fit the subject matter, teachers' preferences, personalized learning environment 30 and students 20 being taught. The present invention's educational tool system 10 is not limited to just these embodiments for use in middle school math classes and may be customized for use in any subject or learning environment equipped as described herein.

The present invention's displays of student-level indicators 72, student-level “deep-dive” screens 74, and class-level summaries 76 aid in the creation of an orchestration tool or educational tool system 10 according to the present invention, which enables the teacher 22 to more fully incorporation both the physical reality and the technology-provided real-time analytics 52 into a more ideal strategy for aiding students 20 and teaching in personalized learning environments 30. While some students 20 may raise their hands to seek help from the teacher 22, an educational tool system 10 according to the present invention may recommend that other student(s) 20 need help based upon the data 50 that is being gathered and analyzed about how the student(s) 20 are interacting with the educational software. Thus, students 20 who need help but are not actively seeking it can be flagged to receive help. In this way, a teacher 22 can more effectively identify and help the students 20 who are struggling with a problem or lesson. The present invention improves, not only a teacher's awareness of what is happening in the classroom, but also supports the teacher's decision-making and enacting real-time help in the classroom.

Investigating Student Learning Enhancement with One Embodiment of the Present Invention.

One embodiment of the present invention's educational tool system 10 was involved the investigation of the hypothesis that real-time teacher/AI co-orchestration, supported by real-time analytics 52 from an ITS, would enhance student learning compared with both (a) business-as-usual for an ITS classroom, and (b) classroom monitoring support without advanced analytics 52 (a stronger control than (a), as described below).

To test these hypotheses, this embodiment 10 of the present invention was evaluated in a 3-condition experiment with 343 middle school students 20, across 18 classrooms, 8 teachers 22, and 4 public schools (each from a different school district) in a large U.S. city and surrounding areas. All participating teachers 22 had at least 5 years of experience teaching middle school mathematics and had previously used an ITS in their classroom. The study was conducted during the first half of the students' school year, and none of the classes participating in this study had previously covered equation-solving topics beyond simple one-step linear equations (e.g., x−2=1).

Classrooms were randomly assigned to one of three conditions, stratified by teacher 22. In the “Glasses+Analytics” condition, teachers 22 used the full version of one embodiment of the present invention's mixed-reality smart glasses 62, including all displays described above. In the business-as-usual (“noGlasses”) condition, teachers 22 did not wear this embodiment of the present invention mixed-reality smart glasses 62 during class, and thus did not have access to real-time analytics 52. Also included was a third condition (“Glasses”) in which teachers 22 used a reduced version of this one embodiment of the present invention's mixed-reality smart glasses 62 with only its monitoring functionality (i.e., without any of its advanced analytics 52). This condition was included because prior empirical findings suggested that students' mere awareness that a teacher 22 is monitoring their activities within an ITS may have a significant effect on student learning (e.g., by discouraging, and thus decreasing the frequency of maladaptive learning behaviors such as gaming-the-system). In the Glasses condition, teachers 22 only retained the ability to “peek” at students' screens from any location in the classroom, using the glasses 62 (although without the line-by-line annotations present in this embodiment's mixed-reality smart glasses' “Current Problem” screen). All of this embodiment's mixed-reality smart glasses' student indicators 72 were replaced by a single, static symbol (a faint circular outline) that did not convey any information about the student's state. Further, the “Areas of Struggle” deep dive screens 74 and the class-level displays 76 were hidden. This stripped-down version of this embodiment's mixed-reality smart glasses 62 was to encourage teachers 22 to interact with the glasses 62, thereby minimizing differences in students' perceptions between the Glasses+Analytics and Glasses conditions. The Glasses condition bears some similarity to standard classroom monitoring tools, which enable teachers 22 to peek at student screens on their own desktop or tablet display.

All teachers 22 participated in a brief training session before the start of the study. Teachers 22 were first familiarized with Lynnette™, the tutoring software that students 20 would use during the study. In the Glasses+Analytics and Glasses conditions, each teacher 22 also participated in a brief (30-minute) training with the mixed-reality smart glasses 62 before the start of the study. In this training, teachers 22 practiced interacting with two versions of the glasses 62 (Glasses and Glasses+Analytics) in a simulated classroom context. At the end of this training, teachers 22 were informed that, for each of their classes, they would be assigned to use one or the other of these two designs. Classrooms in each of the three conditions followed the same procedure. In each class, students 20 first received a brief introduction to Lynnette™ from their teacher 22. Students 20 then worked on a computer-based pre-test for approximately 20 minutes, during which time the teacher 22 provided no assistance. Following the pretest, students 20 worked with the tutor for a total of 60 minutes, spread across two class sessions. In all conditions, teachers 22 were encouraged to help their students 20 as needed, while they worked with the tutor. Finally, students 20 took a 20-minute computer-based post-test, again without any assistance from the teacher 22. The pre- and posttests focused on procedural knowledge of equation solving. Two isomorphic test forms that varied only by the specific numbers used in equations were used in this experiment. The tests forms were assigned in counter-balanced order across pre- and post-test. The tests were graded automatically, with partial credit assigned for intermediate steps in a student's solution, according to Lynnette™ cognitive model.

In the Glasses and Glasses+Analytics conditions, the mixed-reality smart glasses 62 of this one embodiment of the present invention were used to automatically track a teacher's physical position within the classroom relative to each student 20, moment-by-moment (leveraging the glasses' indicators 70 as mixed-reality proximity sensors). Teacher time allocation was recorded per student 20 as the cumulative time (in seconds) a teacher 22 spent within a 4-ft radius of that student 20 (with ties resolved by relative proximity). Given the observation that teachers 22 in both of these conditions frequently provided assistance remotely (i.e., conversing with a student 20 from across the room, while monitoring her/his activity using the glasses 62), teacher time was also accumulated for the duration a teacher 22 spent peeking at a student's screen via the mixed-reality smart glasses 62. In the noGlasses condition, since teachers 22 did not wear the mixed-reality smart glasses 62, time allocation was recorded via live classroom coding (using the LookWhosTalking tool) of the target (student 20) and duration (in seconds) of each teacher visit. In addition to test scores and data 50 on teacher time allocation, tutor log data 50 was analyzed to investigate potential effects of condition on students' within-software behaviors.

Results: Fifty-seven students 20 were absent for one or more days of the study and were excluded from further analyses. The data for the remaining 286 students 20 was analyzed. Given that the sample was nested in 18 classes, 8 teachers 22, and 4 schools, and that the experimental intervention was applied at the class level, hierarchical linear modeling (“FILM”) was used to analyze student learning outcomes. Three-level models had the best fit, with students 20 (level 1) nested in classes (level 2), and classes nested in teachers 22 (level 3). Class track (low, average, or high) was used as a level-2 covariate. Both 2-level models, (with students 20 nested in classes) and 4-level models (with teachers 22 nested in schools) had worse fits according to both AIC and BIC, and 4-level models indicated little variance on the school level. This experiment reported r for effect size. An effect sizer above 0.10 is conventionally considered small, 0.3 medium, and 0.5 large.

Effects on Student Learning: To compare student learning outcomes across experimental conditions, HLMs with test score as the dependent variable, and test type (pretest/posttest, with pretest as the baseline value) and experimental condition as independent variables (fixed effects) were used. For each fixed effect, a term was included for each comparison between the baseline and other levels of the variable. For comparisons between the Glasses+Analytics and noGlasses conditions, noGlasses was used as the condition baseline. Otherwise, Glasses was used as the baseline.

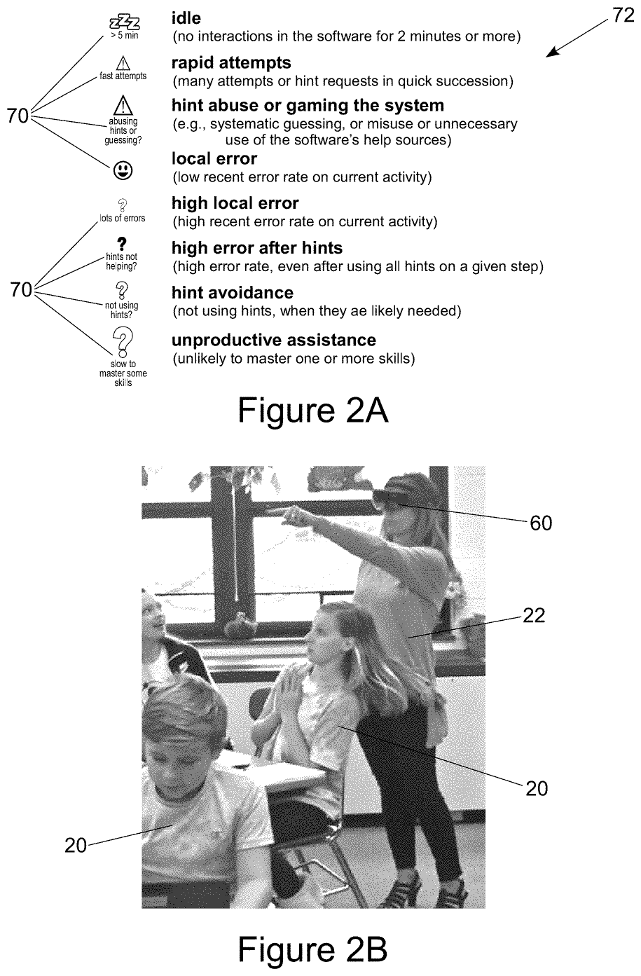

Across conditions, there was a significant gain between student pretest and posttest scores (t(283)=7.673, p=2.74*10−13, r=0.26, 95% CI [0.19, 0.34]), consistent with results from prior classroom studies using Lynnette™, which showed learning gain effect size estimates ranging from r=0.25 to r=0.64. FIG. 3 shows pre-post learning gains for each condition. There was a significant positive interaction between student pre/posttest and the noGlasses/Glasses+Analytics conditions (t(283)=5.897, p=1.05*10−8, r=0.21, 95% CI [0.13, 0.28]), supporting the hypothesis that real-time teacher/AI co-orchestration, supported by analytics 52 from an ITS, would enhance student learning compared with business-as-usual for ITS classrooms.

Decomposing this effect, there was a significant positive interaction between student pre/posttest and the noGlasses/Glasses conditions (t(283)=3.386, p=8.08*10−4, r=0.13, 95% CI [0.02, 0.23]), with a higher learning gain slope in the Glasses condition, indicating that relatively minimal classroom monitoring support, even without advanced analytics, can positively impact learning. In addition, there was a significant positive interaction between student pre/posttest and the Glasses/Glasses+Analytics conditions (t(283) =2.229, p=0.027, r=0.11, 95% CI [0.02, 0.20]), with a higher slope in the Glasses+Analytics condition than in the Glasses condition, supporting the hypothesis that the present invention's real-time teacher analytics 52 enhance student learning, above and beyond any effects of monitoring support alone (i.e., without advanced analytics 52).

Aptitude-Treatment Interactions on Student Learning: This one embodiment of the present invention was then investigated for how the effects of each condition might vary based on students' prior domain knowledge. This embodiment was designed to help teachers 22 quickly identify students 20 who are currently struggling (unproductively) with the ITS, so that they could provide these students 20 with additional, on-the-spot support. If this embodiment was successful in this regard, one would expect to see an aptitude-treatment interaction, such that students 20 coming in with lower prior domain knowledge (who are more likely to struggle) would learn more when teachers 22 had access to this embodiment of the present invention's real-time analytics 52.

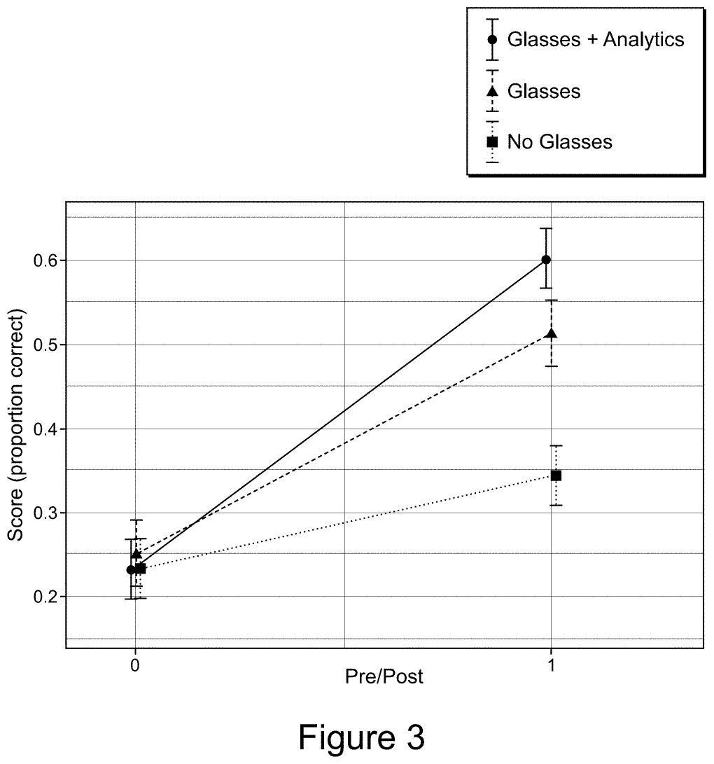

An HLM with posttest as the dependent variable and pretest and experimental condition as level-1 covariates, modeling interactions between pretest and condition, was designed. FIG. 4A shows student posttest scores plotted by pretest scores (in standard deviation units) for each of the three conditions. As shown, students 20 in the Glasses condition learned more overall, compared with the noGlasses condition, but the disparity in learning outcomes across students 20 with varying prior domain knowledge remained the same. For students 20 in the Glasses+Analytics condition, the posttest by pretest curve was flatter, with lower pretest students 20 learning considerably more than in the other two conditions. There was no significant interaction between noGlasses/Glasses and student pretest. However, there were significant negative interactions between student pretest scores and noGlasses/Glasses+Analytics (t(46)=−2.456, p=0.018, r=−0.15, 95% CI [−0.26, −0.03]) and Glasses/Glasses+Analytics (t(164)=−2.279, p=0.024, r=−0.16, 95% CI [−0.27, −0.05]), suggesting that a teacher's use of the present invention's real-time analytics 52 may serve as an equalizing force in the classroom.

Effects on Teacher Time Allocation: As an additional way of testing whether the real-time analytics 52 provided by this embodiment of the present invention had their intended effect, an HLM was fitted with teacher time allocation, per student 20, as the dependent variable, and student pretest score, experimental condition, and their interactions as fixed effects. FIG. 4B shows teacher time, plotted by student pretest, for each condition. As shown, in the Glasses+Analytics condition, teachers 22 tended to allocate considerably more of their time to students 20 with lower prior domain knowledge, compared to the other conditions. There was no significant main effect of noGlasses/Glasses on teacher time allocation (t(211)=0.482, p=0.63, r=0.03, 95% CI [0, 0.14]), nor a significant interaction with pretest. However, there were significant main effects of noGlasses/Glasses+Analytics (t(279)=2.88, p=4.26*10−3, r=0.17, 95% CI [0.06, 0.28]) and Glasses/Glasses+Analytics (t(278)=2.02, p=0.044, r=0.12, 95% CI [0.01, 0.23]) on teacher time allocation. In addition, there were significant negative interactions between student pretest and noGlasses/Glasses+Analytics (t(279)=−2.88, p=4.28*10−3, r=−0.17, 95% CI [−0.28, −0.05]) and Glasses/Glasses+Analytics (t(275)=−3.546, p=4.62*10−4, r=−0.23, 95% CI [−0.33, −0.11]).

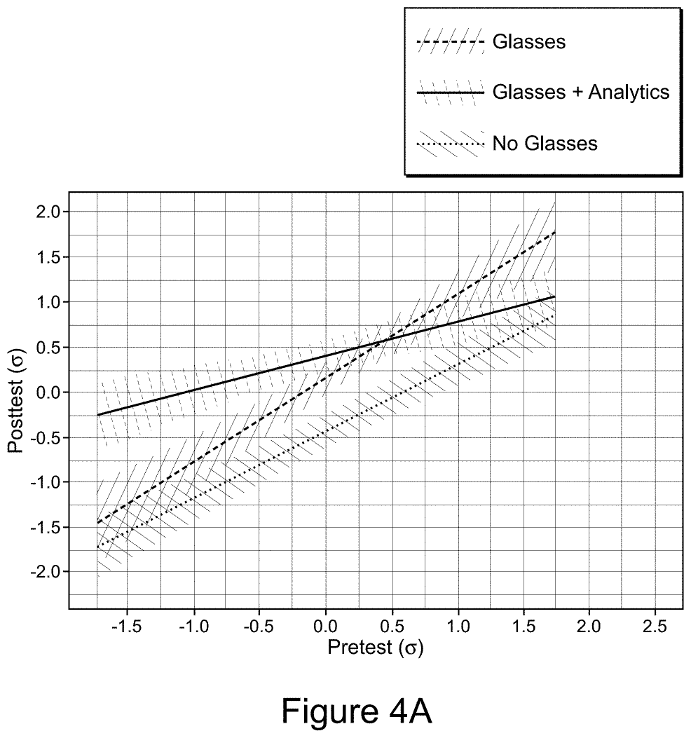

The manner in which teachers' relative time allocation across students 20 may have been driven by the real-time analytics 52 presented in the Glasses+Analytics condition also was investigated. Specifically, whether and how teacher time allocation varied across conditions, based on the frequency with which a student 20 exhibited each of the within-tutor behaviors/states detected by this embodiment of the present invention and this embodiment's student indicators 72 was investigated. HLMs with teacher time allocation as the dependent variable were constructed, and the frequency of student within-tutor behaviors/states, experimental condition, and their interactions as fixed effects. As shown in FIG. 5, Row 3 shows relationships between student within-tutor behaviors/states and teacher time allocation across students 20, for the Glasses+Analytics vs. noGlasses (GA v. nG) comparison. As shown, teachers' time allocation across students 20 appears to have been influenced by the present invention's real-time indicators 70. Compared with business-as-usual (FIG. 5, Row 3), teachers 22 in the Glasses+Analytics condition spent significantly less time attending to students 20 who frequently exhibited low local error, and significantly more time attending to students 20 who frequently exhibited undesirable behaviors/states detected by this embodiment of the present invention, such as unproductive persistence (or “wheel-spinning”). FIG. 5, Rows 1 and 2 show estimates for Glasses vs. noGlasses (G v. nG) and Glasses+Analytics vs. Glasses (GA v. G), respectively. As shown, there were no significant differences in teacher time allocation due to the introduction of the glasses 62 themselves, suggesting this embodiment of the present invention's overall effects on teacher time allocation may result primarily from teachers' use of the present invention's advanced analytics 52 presented in the GA condition.

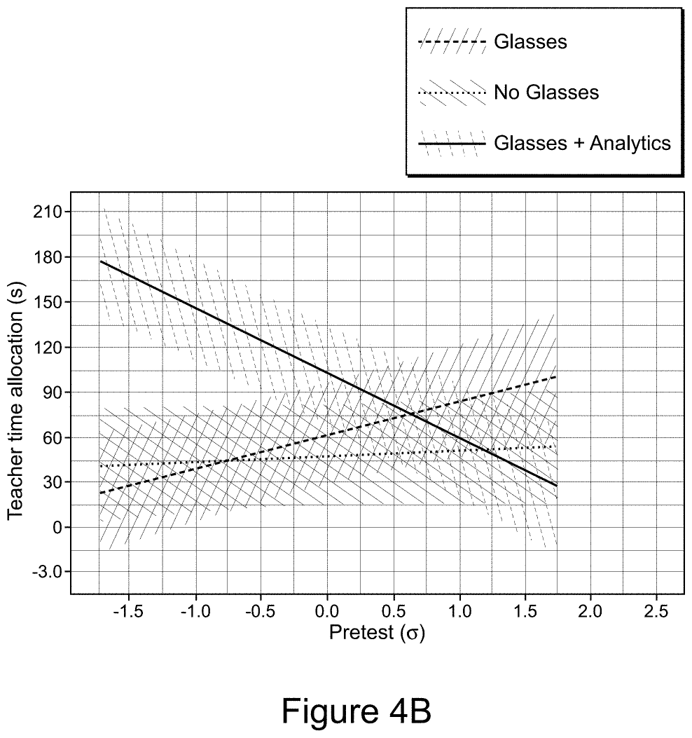

Effects of Classroom Monitoring Support and Real-time Teacher Analytics on Student-level Processes: To investigate potential effects of experimental condition on the frequency of student within-tutor behaviors and learning states detected by this embodiment of the present invention, HLMs were constructed with students' within-tutor behaviors/states as the dependent variable, and pretest score and experimental condition as fixed effects. In FIG. 6, Row 3 shows estimated effects of classroom condition on the frequency of student within-tutor behaviors/states for Glasses+Analytics vs. noGlasses (GA v. nG). Compared with business-as-usual, students 20 in the Glasses+Analytics condition exhibited less hint avoidance or gaming/hint abuse, were less frequently detected as unproductively persisting or making rapid consecutive attempts in the tutoring software and exhibited less frequent high local error. In addition, students 20 in the Glasses+Analytics condition were more frequently idle in the software, and more frequently exhibited low local error. FIG. 6, Row 1 suggests that that the introduction of the glasses 62, even without real-time teacher analytics 52, may have had a considerable influence on students' behavior within the software. By contrast, there were no significant differences between the Glasses+Analytics and Glasses conditions. These results suggest that, despite the ostensible positive effects of real-time teacher analytics 52 on student learning outcomes, some of the largest effects of this embodiment of the present invention on students' within-tutor behavior may result primarily from teachers' 22 use of the monitoring support provided in the Glasses condition.

Discussion and conclusions: This 3-condition classroom experiment was designed to investigate the effects of this one embodiment of the present invention's educational tool system 10 for incorporating a real-time, wearable cognitive augmentation device 60 on student learning in ITS classrooms 30. The findings indicate that teachers' use of this embodiment of the present invention's real-time, wearable cognitive augmentation device 60, as part of an educational tool system 10 and method of incorporating mixed-reality real-time awareness in artificial intelligence-enhanced classrooms, resulted in higher learning gains with the ITS. In addition, presenting teachers 22 with real-time analytics 52 about student learning, metacognition, and behavior at a glance had a positive impact on student learning with the ITS, above and beyond the effects of monitoring support alone (without any advanced analytics 52). The incorporation of the real-time analytics 52 provided by this embodiment of the present invention into these educational environments appear to have served as an equalizing force in the classroom: driving teachers' time towards students 20 of lower prior ability and narrowing the gap in learning outcomes between students 20 with higher and lower prior domain knowledge.

Interestingly, part of this embodiment of the present invention's overall effect on student learning appears to be attributable to monitoring support alone. Follow-up correlational analyses suggested that a teacher's use of the glasses 62, with monitoring support (i.e., support for peeking at a student's screen remotely), but without advanced analytics 52, may reduce students' frequency of maladaptive learning behaviors (such as gaming/hint-abuse) without significantly influencing teachers' time allocation across students 20. More specifically, the observed learning benefits of monitoring support may be due to a motivational effect, resulting from students' awareness that a teacher 22 is monitoring their activities in the software, and/or due to a novelty effect. The monitoring support provided in the Glasses condition also may have a positive effect on teacher behavior that is not reflected in the way they distributed their time across students 20 (e.g., an effect upon teachers' verbal or non-verbal communication).

Although much prior work has focused on the design, development, and evaluation of teacher analytics tools, very few studies have evaluated effects on student learning. The experiments and research discussed herein were the first to demonstrate that real-time teacher analytics 52 can enhance students' learning outcomes, within or outside the area of AIED and intelligent tutoring systems (personalized learning environments 30). While the current study involved teachers 22 with at least five years of mathematics teaching experience, the system and method of the present invention also can be adapted for use with less experienced teachers 22 and for different subjects.

Investigating Wearable, Cognitive Augmentation for K-12 Teachers.

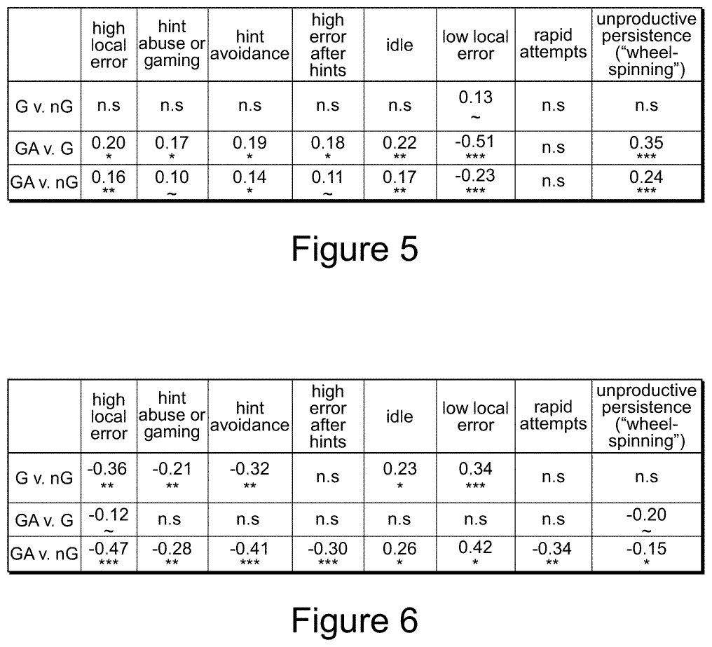

One embodiment of the present invention was evaluated to better understand what real-time information about student learning and behavior would be most helpful to K-12 teachers 22 in a personalized learning environment 30 and how teachers 22 would use such information to inform their real-time decision-making during a class session. To those ends, a series of iterative design studies were conducted with a total of 16 middle school math teachers 22, from 9 schools and 6 school districts in Pittsburgh and surrounding areas (as shown in FIG. 7). All participating teachers 22 had previously used an adaptive learning technology in their classrooms, and 12 of 16 teachers 22 had previously used an ITS as a regular component of their teaching.

Determining the data to collect and the indicators to display: For any embodiment of the present invention, a determination needs to be made as to what data 50 to collect from the students 20 and the classroom and what analytics 52 to display to the teacher 22. In one embodiment of the present invention, this determination was made by conducting storyboarding and lo-fi prototyping sessions with a series of three middle school math teachers 22 from schools A, C, and F (see FIG. 7.) For all studies, two researchers (the 1st and 2nd authors) visited middle schools and worked with teachers 22 in their own classrooms.

For this one embodiment of the present invention educational tool system 10, the determination of what data 50 to gather and display was accomplished by asking the teacher 22 to view a computer screen while pretending to wear smart glasses 62. The teacher 22 then views layers of information on the computer screen (simulating the experience of using smart glasses 62). Floating text labels (indicators 70) appeared over students' heads, alerting teachers 22 to current detected states, such as struggling in the software, potentially off-task, or frequently making careless errors. In addition, two class-level analytics displays 74 popped up along the classroom's whiteboard, visible only through the smart glasses 62, based on teachers' expressed desires for real-time class-level information. One of these displays showed a list of skills that multiple students 20 in the class had practiced but few had mastered, and the other showed a sorted list of common errors that multiple students 20 in the class had recently exhibited.

In response to such simulated displays, teachers 22 remarked on any information that was visible in the image but not so useful and/or information that was not visible but might be useful to have to guide their real-time decision-making. In designing this embodiment of the present invention, teachers 22 expressed a desire to see when students 20 were frequently making careless errors and all teachers 22 expressed a desire to see positive information about individual students 20, not just negative information. In particular, all teachers 22 wanted to be able to see when students 20 have been performing particularly well in the software recently. Teachers 22 found this valuable for several reasons, including but not limited to: motivating themselves (since seeing nothing but negative alerts might be discouraging), motivating students 20 (by identifying and praising students 20 who have been doing well lately), and identifying students 20 who may be under-challenged by the software.

Alternatively, when designing a specific embodiment of the educational tool system 10 and method of the present invention, real mixed-reality smart glasses 62 can be used instead of a computer-simulated version. One embodiment of the present invention was designed via prototyping sessions with a series of five math teachers 22, from schools C, E, G, H, and I from FIG. 7. Two researchers visited middle schools in Pittsburgh and surrounding areas and worked with teachers 22 in their own classrooms. Each study lasted 90 minutes: the teacher 22 wore the HoloLens, one type of mixed-reality smart glasses 62, during an hour-long experience prototyping phase, while experimenting with different configurations of analytics displays and thinking aloud about likely use-cases. This was followed by a 30-minute semi-structured post-interview in which teachers 22 had the opportunity to reflect and provide more detailed design feedback. For these and subsequent studies, middle school classrooms using tutoring software for equation-solving were the focus.

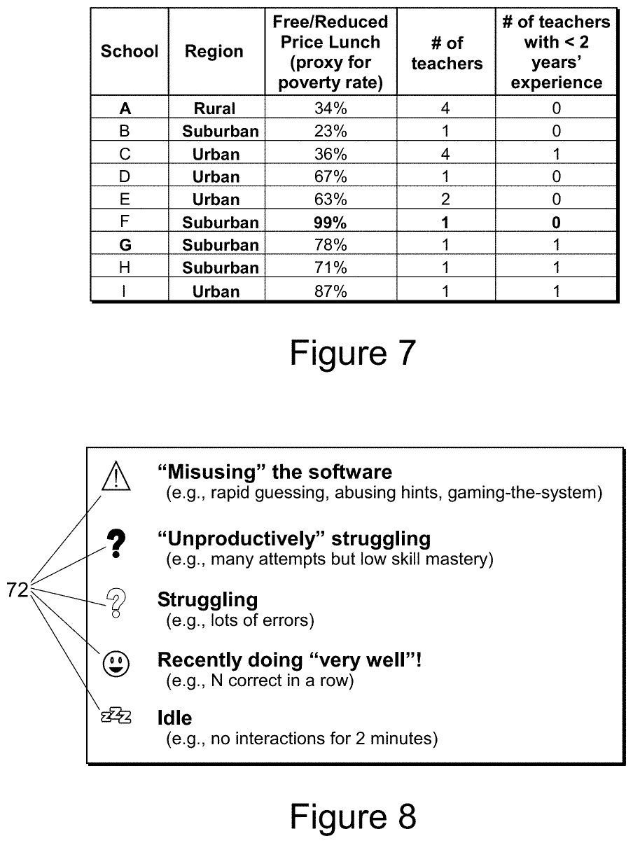

Again, for this embodiment of the present invention, prototype designs of the educational tool system 10 and method were designed based upon the teacher's input regarding what data 50 to gather and what analytics 52 to display (the student-level and class-level or student-combined analytics 56.) For this process, the teacher 22 could see indicators 70 (like those shown in FIG. 8) floating over empty student seats, and class-level analytics displays appearing as “wall decorations”, which the teacher 22 could reposition.

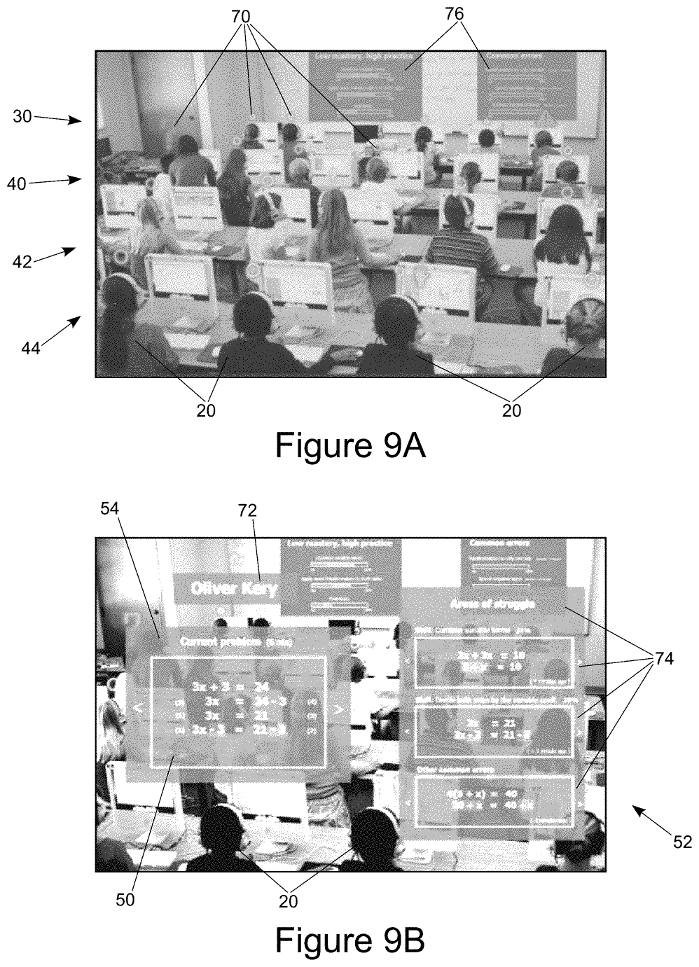

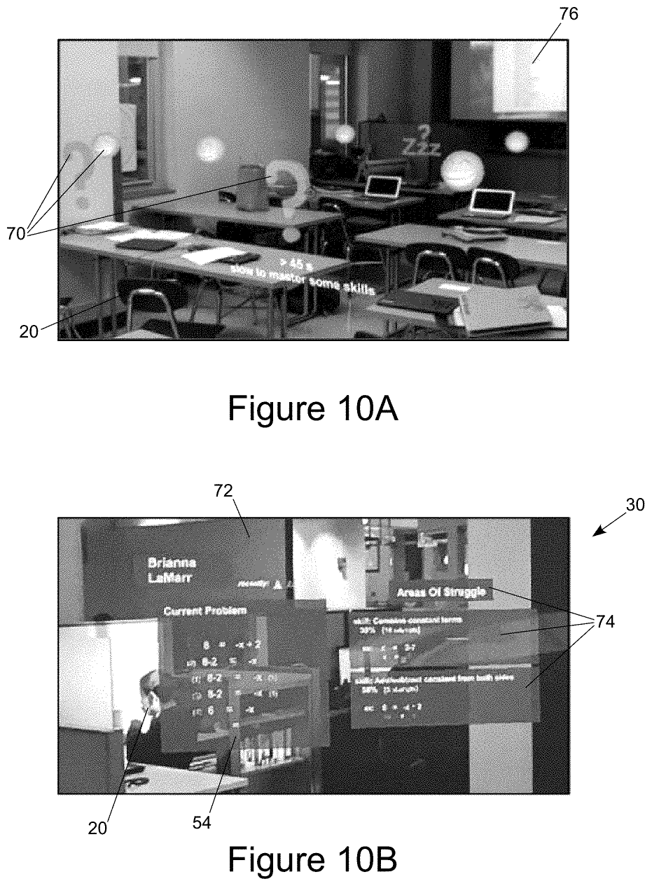

In designing this specific embodiment of the educational tool system 10 and method of the present invention, any and all indicators 70 can be displayed and the inclusion or exclusion of any could be edited to reflect the teacher's desired display. Teachers 22 could reposition these information displays and experiment by decorating their classrooms with different combinations of displays. The results of research conducted on this embodiment of the present invention lead to the creation of five major categories of student learning states and behaviors and, thus, student-level indicators 72 as shown in FIG. 8. This embodiment of the present invention reflects the teachers' strong preference to keep these indicators 70 simple—displaying a single graphical symbol above each student's head (as in FIG. 9A) to avoid information overload. More specifically, FIG. 9A shows the teacher's default view of the class. Each student 20 has an indicator 70 display floating above her/his head, and two class-level analytics displays 76 are positioned at the front of the class. One shows skills practiced by many students 20 but mastered by few; the other shows errors recently exhibited by many students 20. FIG. 9B shows a possible illustration of a deep-dive screen 74 shown if a teacher 22 ‘clicks’ on an indicator 70. However, in some embodiments of the present invention, teachers 22 can also access brief elaborations on-demand (e.g., by gazing at an indicator 70, as in FIG. 10A), which could aid in understanding why an indicator 70 was appearing for a student 20 at a particular time. FIG. 10B also shows one possible illustration of a teacher's view of deep-dive screens 74.

In some embodiments of the present invention, in addition to seeing indicators 70 reflecting a student's current “state”, it may be useful for the teacher 22 to see detected states preceding the current state. For example, if a student 20 is currently “idle” or “misusing the software” in some way, it can be useful to know whether that student 20 was also recently struggling. Teachers 22 could then interpret the prior struggle as a potential cause of the current behavior and respond accordingly.

One of the many advantages of the present invention is that it treats the entire classroom or personalized learning environment 30 as though it were a dashboard for the educational tool system 10 of the present invention. The present invention creates a natural mixed-reality with information displays that are distributed throughout the physical classroom spaces. In the absence of a dashboard, teachers 22 were used to monitoring their students 20 by scanning the physical classroom (e.g., reading student body language), and “patrolling” rows of student seats, to catch glances of students' screens. The present invention enables teachers 22 to supplement the analytics 52 that they see with the students' body language and vice versa.

Another advantage to the present invention is that it gives teachers 22 private access to analytics 52 that they would not otherwise be comfortable sharing with their students 20, such as by having them displayed on a desktop or laptop computer screen where a student 20 might see the analytics 52. This attribute of some embodiments of the present invention enables teachers 22 to have information available to them that students 20 might not be willing to share openly for fear of being ridiculed or embarrassed.

In certain learning environments and teaching situations, providing real-time access to the students' raw data 50 may be as valuable as providing the analytics 52 based up on such data 50. As depicted in FIG. 9B, raw examples of errors that the student 20 has recently exhibited are also shown. Showing these example errors is crucial not only in helping the teacher 22 perform further diagnosis, but also in supporting teacher trust or enabling the teacher 22 to “override” the system's judgments if needed.

Another example of information that can be provided to the teacher 22 in one embodiment of an educational tool system 10 and method according to the present invention is a live feed of a student's work within their current activity (optionally annotated with indicators 70). This allows a teacher 22 to observe a student's work without the student 20 changing his/her behavior in response to the teacher 22 physically approaching the student 20.

Alternative embodiments of the present invention can include an option for students 20 to discretely seek help from the teacher 22. An “Ask the teacher” button can be programed into the educational tool system 10 that would trigger a “raised hand” symbol (or similar indicator 70) within the real-time, wearable cognitive augmentation device 60. It is expected that, by providing students 20 with a way to request help that is not easily visible to other students 20, more students 20 will feel comfortable asking for help.

Various embodiments of the present invention educational tool system 10 and method can utilized and display analytics 52 that are “frozen” at a single time slice or by monitoring a class session unfolding over time, using real student data 50. A set of automated detectors within the gathering system 42 and/or processing system 44 of student learning and behavior can be developed to provide teachers 22 with a selection of key real-time indicators 70. When embedded in the present invention, the real-time analytics 52 generated by these detectors would then be streamed to the processing system 44, where they would update mixed-reality displays in the real-time, wearable cognitive augmentation device 60. In one embodiment of the present invention, these displays can consist of three main types: student-level indicators 72, student-level “deep-dive” screens 74, and class-level summaries 76 (as shown in FIGS. 9 and 10). Student-level indicators 72 and class-level summaries 76, optionally, may be always visible to the teacher 22 by default—with student-level indicators 72 appearing above corresponding students' heads (based on teacher-configurable seating charts), and with class-level summaries 76 appearing at teacher-configurable locations throughout a classroom. If a teacher 22 gazes at a particular student's indicator 72, a brief elaboration about the currently displayed indicator 72 would be displayed. For example, if a student 20 is detected as recently struggling in the software, a teacher 22 could glance at that student's indicator 72 to reveal how long this alert had been active, and whether the student 20 seems to be avoiding using the software's built-in hints. If no indicators 72 were currently active for a student 20, a circular outline could be displayed above that student's head (as illustrated in FIG. 9).

If a teacher 22 clicks on a student's indicator 72 (either by using a small handheld clicker, by making a tapping gesture in mid-air, or by using any other method appropriate to the technology being used), the teacher 22 would see “deep-dive” screens 74 for that student 20, containing more detailed information about a student's path through their current problem, and any consistent areas of struggle that student 20 might be exhibiting. The “current problem” deep-dive screen 74 illustrated in FIG. 9 displays an annotated live feed of a student's work on their current problem. Each problem step can be annotated with the number of hint requests and incorrect attempts that a student 20 had made on that step. The deep-dive screens 74 also allow teachers 22 to view recently active alerts or indicators 70, as shown beside the student's name in FIG. 10.

Indicators 70 can be drawn from a wide variety of sources or created to meet the needs of a particular student 20, teacher 22, personalized learning environment 30, subject matter, etc. One example of a source for indicators 70 is the Educational Data Mining, Artificial Intelligence in Education, and Learning Analytics literatures—where many automated detectors of student learning and behavior have been introduced, based on students' interactions within the software. The software of the present invention also can be designed to automatically log teacher actions during class sessions and, optionally, to send it to an educational data repository. For example, one embodiment of the present invention can be designed to can record time-stamped logs of a teacher's physical proximity to a given student 20 at a given time, the target of a teacher's gaze, and all teacher interactions with the tool.

Another optional design feature of an educational tool system 10 and method of the present invention is providing to teachers 22 the ability to set visual “timers” on an individual student(s) 20 by clicking-and-holding on the student's indicator 70 (or another appropriate request mechanism). This is useful as a reminder to check back with a student 20—for example, if that student 20 appears to be struggling currently, but it is unclear to the teacher 22 whether the student 20 might overcome this struggle on their own within the next several minutes. Another optional design feature is the ability to monitor individual students' activities, while either walking or physically attending to a student 20 seated across the classroom. An embodiment of the present invention can have the “deep-dive” screen 74 “tag along” with them as the teacher 22 walks (instead of hanging in space near the given student 20 and visible only when looking in that direction). Finally, to give teachers 22 “eyes in the back of their heads” another embodiment of the present invention enables teachers 22 to configure ambient, spatial sound notifications. For example, if a student 20 was misusing the software, a teacher 22 could privately perceive a soft notification, as if it were emanating from that student's location in the classroom.

One embodiment of the present invention was evaluated using a series of 6 Replay Enactments. For each session, replay data 50 from a 40-minute class session was used. The replay data 50 was randomly selected from a pool of 5 “average” and “remedial” classes. An “average” class was replayed in 4 sessions, and a “remedial” class was replayed in the remaining two. Advanced classes were omitted from the selection pool, given little between-student variance in test scores. To minimize potential effects of names or seating positions, replayed students 20 were randomly assigned names and positions in each session.

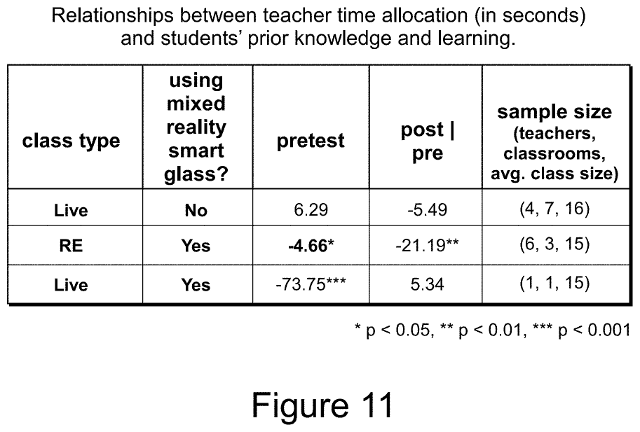

In this evaluated embodiment of the present invention, the indicators 70 positioned above students' heads doubled as proximity sensors within a physical space. Using these mixed-reality sensors, a teacher's allocation of time to a given student 20 was measured as the cumulative time (in seconds) that she or he spent within a 4-ft radius of that student 20. If a teacher 22 was within range of multiple students 20, time was accumulated only for the nearest student 20. Hierarchical linear modeling (“FILM”) was used to predict teachers' time allocation across replayed “students” 20 as a function of either students' prior domain knowledge (measured by a pretest in the original class session) or students' learning during the class (measured by a posttest, controlling for pretest). As is the case in a typical classroom study, teachers 22 did not have access to pre- or post-test data 50, and this data 50 was not used by this embodiment of the present invention. Using 2-level models, with students 20 nested in classrooms, provided a better fit than 1-level or more complex models. Standardized coefficients for student-level variables are provided in row 2 of the table shown in FIG. 11. As shown, teachers 22 using the present invention in REs spent significantly more time attending to “students” 20 with relatively lower pretest scores, or posttest scores (controlling for pretest).

By contrast, in an in-vivo classroom study that was run with 4 teachers 22 across 7 real middle school classrooms, students 20 worked with Lynnette™ while teachers 22 monitored and helped their students 20 (without access to a real-time, wearable cognitive augmentation device 60). Performing the same analysis as above, but this time with data 50 from this classroom study (with time allocation recorded via manual classroom coding), again it was found that 2-level models provided the best fit. Coefficients for these models are provided in the table in FIG. 11 (row 1). Although all teachers 22 reported attempting to devote most of their time to students 20 whom they expected would struggle most with the material, we found no significant relationships between students' pre- or posttest scores and teacher time allocation. Therefore, it can be concluded that the present invention aids teachers 22 in focusing on and helping students 20 with lower prior knowledge. Early results from a 1-hour pilot study, with one teacher 22 using the present invention in a real classroom (row 3 of the table shown in FIG. 11) were consistent with this finding.

More importantly, these results are evidence that the present invention successfully aids teachers 22 in identifying those students 20 who would have gone on to exhibit the lowest learning in a real classroom session—potentially representing a subset of students 20 who benefit the least from working with the tutoring software alone, and who may stand to benefit the most from a teacher's help. Since Replay Enactments remove the possibility of a causal arrow from teacher behavior to students' learning within the software, this method enables us to investigate counterfactuals such as the above, for different forms of teacher augmentation. Conversely, classroom studies—although costly to run—allow investigation of effects of a tool in the context of many competing influences on a teacher's attention and judgment.

In sum, the research discussed herein demonstrates that AIED systems can integrate human and machine intelligence to support student learning. In addition, this research illustrates that the kinds of analytics 52 already generated by ITSs, using student modeling techniques originally developed to support adaptive tutoring behavior, provide a promising foundation for real-time, wearable cognitive augmentation devices 60 and the educational tool systems 10 and methods that incorporate them. The present invention can be applied to a variety of educational environments beyond K-12 classrooms. Possible applications include various educational environments beyond classrooms, including but not limited to professional educational settings, tutoring services, and any environment where an personalized learning environment 30 is used to educate or evaluate skills and a teacher/proctor/monitor/supervisor 22 desires analytics 52 on an individual's experience within the personalized learning environment 30 in a form that is unobtrusive and enables the teacher 22 to view the classroom, the students 20, and the analytics 52 while moving around the room and engaging with the students 20.

One alternative embodiment of the present invention educational tool system 10 is a classroom in which students 20 work on laptops with self-paced learning software, creating a personalized learning environment 30. In this embodiment, the teacher 22 may wear a real-time, wearable cognitive augmentation device 60 that projects real-time information or analytics 52 about students learning, behavior, and metacognition (as well as a teacher's own prior interactions with each student 20) within the teacher's view of the classroom, and/or that presents the teacher with ambient auditory notifications.

Another alternative embodiment of the present invention includes a hospital setting as a personalized learning environment 30, in which students 20 are gathered in small groups, each working at their own pace, practicing medical procedures on patient care manikins. The teacher 22 may wear wireless earpieces (or any real-time, wearable cognitive augmentation device 60), which provide to the teacher 22 brief, real-time automated suggestions regarding which group to help next, what the group seems to need help with, and how the teacher 22 might most effectively help the group(s). In such a personalized learning environment 30, one option for the data gathering system 42 could involve the tools that the students 20 are using. Such tools can be fitted with sensor(s), accelerometer(s) and/or audio sensors that gather data 50 from the students 20 and the group to be fed into a processing system 44 and the real-time, wearable cognitive augmentation device 60.

A similar, yet alternative, embodiment of the present invention involves the use of an educational tool system 10 according to the present invention in a culinary personalized learning environment 30 in which the culinary tools are equipped to gather data 50 on the students 20 as part of the data gathering system 42. The hospital/medical school embodiment and the culinary school embodiment exemplify the wide variety of personalized learning environments 30, data gathering systems 42 and processing systems 44 that are encompassed by the present invention.

Another embodiment of the present invention educational tool system 10 and method is an instrumented makerspace (i.e., a makerspace equipped with sensors to sense various aspects of student and/or teacher behavior, without requiring that students 20 are working on computer-based activities), where students 20 work on open-ended project based learning activities. Within this embodiment, the teacher 22 may wear a smartwatch (or any real-time, wearable cognitive augmentation device 60) that provides the teacher 22 with haptic notifications (i.e., patterns of vibrations that the teacher is able to recognize as corresponding to specific messages) (or any other form of displayed analytics 52) to let the teacher 22 know when they have been spending most of their time during class with just a small subset of students (or any other information relevant to that teacher 22 and class.) Teachers 22 can choose to see analytics 52 about their distribution of time across students 20 either during the current class session only, or across the last however many class sessions. In addition to analytics 52 about the teacher's behavior, the real-time, wearable cognitive augmentation device 60 may also alert the teacher 22 when students 20 appear to be “stuck” while working on their projects or of any other relevant information.

What is claimed is:

1. An educational tool system having at least one student and at least one teacher, comprising:
a personalized learning environment;
a passive feedback system that gathers data on the at least one student and converts it to at least one type of analytics selected from the group consisting of student-specific analytics and student-combined analytics; and
a real-time, wearable cognitive augmentation device that displays the analytics to the at least one teacher.

2. The educational tool system of claim 1, wherein the real-time, wearable cognitive augmentation device allows the at least one teacher to view the analytics while engaging with the at least one student.

3. The educational tool system of claim 1, wherein the real-time, wearable cognitive augmentation devices is selected from the group consisting of a smart watch, smart glasses, at least one earpiece, mixed reality glasses, and a heads-up display.

4. The educational tool system of claim 1, wherein the passive feedback system comprises an intelligent tutoring system.

5. The educational tool system of claim 1, wherein the passive feedback system comprises self-paced learning software.

6. The educational tool system of claim 1, wherein the passive feedback system comprises sensors placed throughout the learning environment to gather data on the at least one student's activities.

7. The educational tool system of claim 1, wherein the passive feedback system comprises at least one recording device to record the activities of the at least one student.

8. The educational tool system of claim 1, wherein the analytics comprise student-specific details.

9. The educational tool system of claim 1, wherein the analytics comprise student-combined details.

10. An educational tool system having at least one student and at least one teacher, comprising:
a personalized learning environment;
a gathering system that gathers data from the at least one student;
a processing system that converts the data into analytics selected from the group consisting of student-specific analytics and student-combined analytics; and
a real-time, wearable cognitive augmentation device that receives and displays the analytics to the at least one teacher.

11. A method of teaching in a personalized learning environment having at least one student and at least one teacher, comprising:
passively gathering data on the at least one student;
processing the data into at least one type of analytics selected from the group consisting of student-specific analytics and student-combined analytics; and
displaying the analytics on a real-time, wearable cognitive augmentation device worn by the at least one teacher.

12. The method of teaching of claim 11, wherein the real-time, wearable cognitive augmentation device allows the at least one teacher to view the analytics while engaging with the at least one student.

13. The method of teaching of claim 11, wherein the real-time, wearable cognitive augmentation devices is selected from the group consisting of a smart watch, smart glasses, at least one earpiece, mixed reality glasses, and a heads-up display.

14. The method of teaching of claim 11, wherein the data is passively gathered using an intelligent tutoring system.

15. The method of teaching of claim 11, wherein the data is passively gathered using self-paced learning software.

16. The method of teaching of claim 11, wherein the data is passively gathered using sensors placed throughout the learning environment to gather information on the at least one student's activities.

17. The method of teaching of claim 11, wherein the data is passively gathered using at least one recording device to record the activities of the at least one student.

18. The method of teaching of claim 11, wherein the analytics comprise student-specific details.

19. The method of teaching of claim 11, wherein the analytics comprise student-combined details.

20. A method of teaching in a personalized learning environment having at least one student and at least one teacher, comprising:
passively gathering data about the at least one student;
processing the data to generate analytics selected from the group consisting of student-specific analytics and student-combined analytics; and
displaying the analytics on a real-time, wearable cognitive augmentation device worn by the at least one teacher.

21. A system for use in educational settings comprising:
a personalized learning environment; and
a real-time, wearable cognitive augmentation device, wherein the device provides real-time analytics of data gathered from the personalized learning environment.

22. A method for use in educational settings comprising:
gathering and processing student data from a personalized learning environment to generate analytics; and
displaying the analytics on a real-time, wearable cognitive augmentation device.

23. A system for use in educational settings comprising:
a computer-based personalized learning environment for students; and
a wearable device that processes and displays real-time analytics gathered from the computer-based personalized learning environment.

24. A system for use in education settings comprising:
a wearable device that presents a teacher with rich, real-time analytics gathered based on one or more student's ongoing interactions within a computer-based learning environment, whereby the analytics are presented to the teacher continuously and in real-time to augment the teacher's perceptions and decision making.
